(19) United States
(12) Patent Application Publication
(10) Pub. No.: US 2016/0030849 A1
(43) Pub. Date: Feb. 4, 2016

(54) Mobile-Based Virtual Reality Game for the Music Industry

(71) Applicants: Music Players Group, LLC, Bala Cynwyd, PA (US); Ground(Cntrl), LLC, Sacramento, CA (US)

(72) Inventor: Brandon Pankey, Bala Cynwyd, PA (US)

(21) Appl. No.: 14/816,381

(22) Filed: Aug. 3, 2015

Related U.S. Application Data
(60) Provisional application No. 62/032,900, filed on Aug. 4, 2014.

(51) Int. Cl. A63F 13/814; A63F 13/792; A63F 13/35

(52) U.S. Cl. CPC A63F 13/814; A63F 13/35; A63F 13/792

(57) ABSTRACT

The present invention describes, in part, a virtual game that provides real-world prizes for online game participation. The game allows users to access an online website having multiple versions of a game that depend upon the type of music the gamer chooses. The online game is able to track and monitor online participation and award points that are redeemed for real-world prizes.

### RELATED APPLICATIONS

This application claims the benefit of U.S. Provisional Patent Application No. 62/032,900, filed Aug. 4, 2014, the disclosure of which is incorporated herein by reference.

### BACKGROUND OF THE INVENTION

1. Field of the Invention

The present invention relates generally to the field of online gaming. More specifically, the present invention relates to a system and a method for inspiring online users to increase then fan experience and develop their knowledge in the music industry.

2. Description of the Prior Art

Online gaming has become a very popular social activity, particularly among the young. The ability for a person to play games and interact with other individuals as part of the entertainment world is extremely desirable.

Many different online websites oiler different types of game play including online gambling, solitaire, poker, and the like. These websites allow an individual to log on and play the games either by themselves or play as a collective group with others. These websites also allow the individual to play with many other players located at distant locations around the globe.

In all of these games, the impersonal interaction with the computer is not very fulfilling and there is a gap between real-world matters important to youths and the goals or objectives behind an online game, in addition, the desire and reward for playing a particular game isn't the same as actively participating in the same event as it would unfold in the real world.

Additionally, many online gaming systems allow individuals to collect points for accomplishing specific things in a game, such as winning or answering questions correctly. These points represent a ranking against other individuals playing identical games. Others offer real world rewards only when an individual contributes to the online website such as providing questions to be included into a game play.

In the music world, popular television programs offer excruciating details about an artist's latest exploits. These television programs provide a platform for young viewers to virtually live the life of the artist by following his career. It allows individual viewers to emulate or follow the career of their favorite musical artist, all as a substitute to actually becoming the artist.

Thus a major component of the fen experience in the music industry is where fans follow their favorite musical artist's progression through their career and emulate their favorite musical artist.

However the problem exists that there are no online gaming systems that provide a virtual platform for a gamer to participate in this component of the fan experience. Nor are there online gaming systems that offer real world rewards for achieving the professional success enjoyed the musical artist by the gamers while providing a virtual platform for the gamer to participate in a preferred real world scenario of great interest to young individuals.

A need therefore exists for a system and a method that offers a virtual platform for a gamer to participate in this fan experience and obtain real-world rewards for participating in a real world scenario.

The present invention provides a means to merge social gaming and the music industry in order to further expand the fan experience within the music industry and offer real-world rewards obtained through success by gaming in the virtual world.

### SUMMARY OF THE INVENTION

The present invention describes a game that can be used with a mobile app and other devices which is focused on the music industry. The app provides a virtual reality for the user or gamer to allow the gamer to create an unknown character as an up and coming artist and develop the character into a worldwide superstar. The game contains multiple real life scenarios requiring decisions by the gainer to advance their stardom within the music industry. The garner must make decisions such as, but not limited to, spending money to obtain better musicians for a new band, negotiate a deal with a big-time manager, obtaining a tour bus to play more dates, or releasing new music. The decision process is based on the in-depth experience and knowledge of music industry professionals. Participants are able to further develop and deepen their connection to their favorite musical artist and are provided new opportunities to inspire and excite gamers. The online game offers recording artists the ability to build a new fan base and develop innovative brand recognition by integrating within online gaming. Taken together, the present invention provides a platform to merge social gaming and the music industry in order to enhance and cultivate the fan experience.

### BRIEF DESCRIPTION OF THE DRAWINGS

FIG. 1 is a screen shot of the present invention in an exemplary embodiment. Viewers of the screen shot are asked to select a specific type of music to access and begin the game.

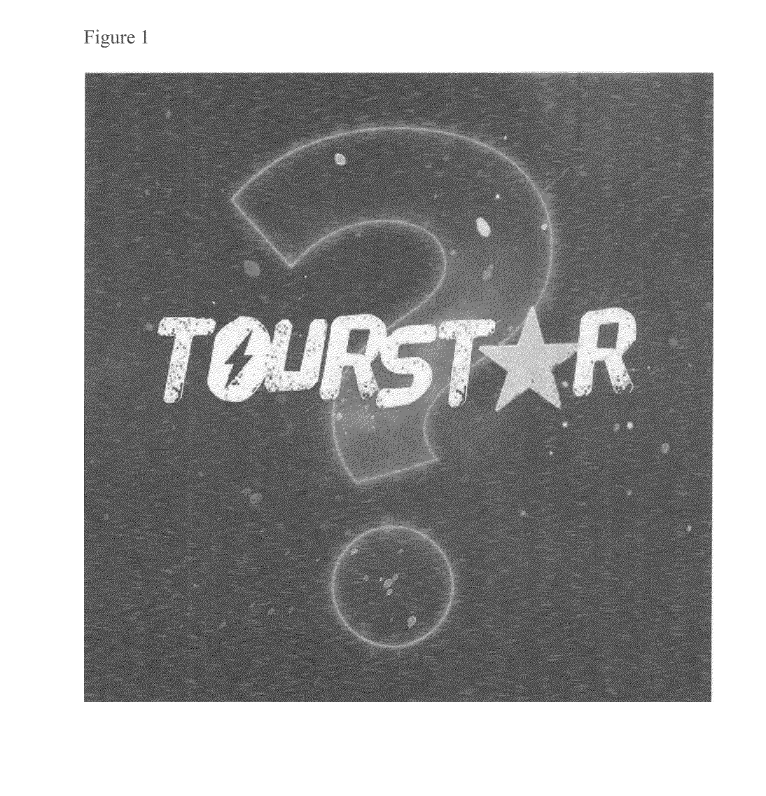

FIG. 2 is a flow chart showing one embodiment to the sequence of steps in winning VIP packages for the gamers favorite musical artist.

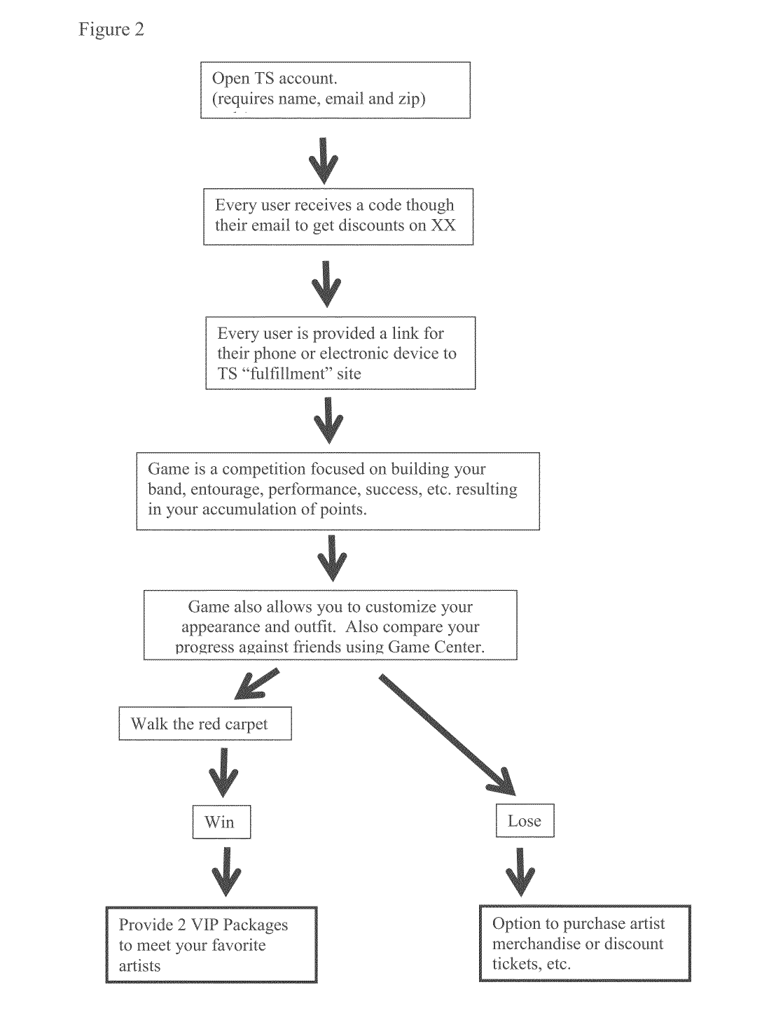

### DESCRIPTION OF THE PREFERRED EMBODIMENTS

The present invention describes a strategy-based game focused on success in the music industry and incorporating real-world experiences in a virtual reality gaming environment that allows the user to create a character which advances from an up and coming artist to a worldwide superstar. The gaming process contains multiple real life scenarios and decisions developed through the experiences of currently active artists such as, but not limited to, Lil' Wayne, Nicki Minaj, The Roots, Jill Scott, Meek Mill and Keri Hilson.

One embodiment of the present invention is the incorporation of real-life decisions encountered in the music industry as an Individual's music career progresses. These decisions are presented to the gamer in a virtual environment to promote a new and extended fan experience by the gamer. Decisions are made related to spending money for better musicians in the gamer's virtual band, negotiating a deal with a virtual big-time manager, moving to a virtual tour bus in order to play more dates, or releasing new music. These are some of the virtual decisions presented to the garner as they compete with fellow gamers to obtain the top point total. Thus, every decision will have a positive or negative implication on the individual's virtual music career.

Another embodiment of the present invention is the opportunity for gamers to win real-world prizes based upon points obtained in a successful virtual music career. Free tickets are awarded to the winning gamer's favorite show. Other prizes include meeting and greeting the winning garner's favorite artist, apparel and other merchandise from the latest brands, or free downloads.

A further embodiment features a means to economically buy tickets for future events, primarily through the use of a mobile device.

A further embodiment features a means to offer discounts for nationwide concerts, currently promoted through a mobile app using a discount code, but other means known in the art are also considered.

The cost for gamers to use the mobile-app game is based on a freemium model. Gamers are able to download the app for free and will be able to play up to level 5 in the game before being asked to pay some amount such as $0.99 for the full unlocked game.

The present invention incorporates the Unity game engine, a cross-platform game creation system which includes a game engine and an integrated development environment (IDE). The game engine is a software platform designed for the creation and development of video games used in video game consoles, mobile devices and personal computers. A rendering engine provides 2D or 3D graphics, a physics engine, sound, scripting, animation, artificial intelligence, networking, streaming, memory management, threading, localization support and a scene graph are also included. Game development is economized by reusing or adapting the same game engine to create different games or to port games to multiple platforms. The IDE is a software application that contains a source code editor, build automation tools and a debugger. The IDE may also contain an intelligent code completion feature, a compiler, and interpreter. The graphics engine in Unity is portable, targeting APIs such as Direct3D on Windows and Xbox 360, OpenGL on Mac, Windows, and Linux, OpenGL ES on Android and IOS and proprietary APIs on video game consoles. This portability allows the present invention to be used with multiple operating systems including Apple IOS, Android, and video game systems such as Xbox One, Playstation 4, and PCs.

An additional embodiment addresses the universal appeal and broad musical interests of all fans to the music industry. These include, but not limited to, hip-hop, pop, metal, country, electronic, R&B, and rock. The present invention considers several unique versions of the game. These mini games focus on various aspects of the music industry and still offer the same enjoyment and excitement experienced by gamers.

The present invention further incorporates a chat box for on-line live support on all aspects of the invention and provides information regarding the real world rewards.

Finally by utilizing the game, the present invention provides a means to create a new ticket marketplace using an IOS game. The game allows geo-targeting of gamers and provides discount ticket opportunities for top nationwide concerts to gamers in specific regions, having specific musical tastes.

While this invention has been described with respect to various specific examples and embodiments, it is to be understood that the invention is not limited thereto and that it can be variously practiced within the scope of the following claims.

1. An on-line virtual reality game in the music industry comprising:
a. an on-line game;
b. a computer device capable of accessing the on-line game by a user;
c. a virtual musical artist progressing In a music career;
d. points for each decision leading to progress in the music career; and
e. real-world prizes wherein the prizes are based on the points obtained by the user upon completion of the game.

2. The virtual reality game of claim 1 wherein the device is a mobile device having an application to enable use of the game.

3. The virtual reality game of claim 1 wherein the decision is from a group consisting of an amount of money spent on supporting musicians for the band, negotiating a new manager agreement, obtaining a tour bus, time period to release new music, and combinations thereof.

4. The virtual reality game of claim 1 wherein the decision is based on decisions from real music industry artists.

5. The virtual reality game of claim 4 wherein the real music industry artists are from a group consisting of Lil' Wayne, Nicki Minaj, The Roots, Jill Scott, Meek Mill, Keri Hilson, and combinations thereof.

6. The virtual reality game of claim 1 further having a software platform for video games having 2D or 3D graphics, sound, scripting, animation, artificial intelligence, networking, streaming, memory management, threading, localization support and a scene graph.

7. The virtual reality game of claim 1 wherein the real-world prizes are selected from a group consisting of free tickets to the user's favorite show, meeting the user's favorite artist, free apparel, free downloads, and combinations thereof.

8. The virtual reality game of claim I further having on-line live support through a chat box.

9. A method for improving a fan's interaction with music industry comprising:
a. accessing an on-line game of claim 1 using a computer device;
b. creating a virtual musical artist to progress in a music career;
c. obtaining points for each decision to progress in the music career wherein the points are converted to real-world prizes; and
d. allowing the fan to purchase discount tickets to events.

10. The method of claim 9 wherein the device is a mobile device having an application to enable use of the game.

11. The method of claim 9 wherein the decision is from a group consisting of an amount of money spent on supporting musicians for the band, negotiating a new manager agreement, obtaining a tour bus, time period to release new music, and combinations thereof.

12. The method of claim 9 wherein the decision is based on decisions from real music industry artists.

13. The method of claim 12 wherein the real music industry artists are from a group consisting of Lil' Wayne, Nicki Minaj, The Roots, Jill Scott, Meek Mill, Keri Hilson, and combinations thereof.

14. The method of claim 9 wherein the real-world prizes are free tickets to the fan's favorite show.

15. The method of claim 9 wherein the real-world prizes are selected from a group consisting of meeting the fan's favorite artist, free apparel, free downloads, and combinations thereof.

16. The method of claim 9 wherein the event is a musical concert promoted through the fan's computer device.

17. The method of claim 9 further providing an on-line live support through a chat box.

18. The method of claim 9 wherein allowing the purchase of discount tickets is geo-targeted.
